(19) United States
(12) Patent Application Publication
(10) Pub. No.: US 2022/0326541 A1
(43) Pub. Date: Oct. 13, 2022

(54) TUBE-LIKE ASSEMBLY FOR ACCESSORY FLOTATION, ACCESSORY SECURING, AND SCRATCH PROTECTION

(71) Applicants: Jeffrey Arkell, Jacksonville Beach, FL (US); Daniel Schreurs, Jacksonville Beach, FL (US)

(72) Inventors: Jeffrey Arkell, Jacksonville Beach, FL (US); Daniel Schreurs, Jacksonville Beach, FL (US)

(21) Appl. No.: 17/229,687

(22) Filed: Apr. 13, 2021

(51) Int. Cl. G02C 5/00; G02C 3/00

(52) U.S. Cl. CPC G02C 5/001; G02C 3/003

(57) ABSTRACT

This invention relates to a device used to attach to eyewear for the purpose of providing buoyancy, securing to the head and temples, and protection from scratches.

### TECHNICAL FIELD

This invention relates to a device used to attach to eyewear for the purpose of providing buoyancy, securing to the head and temples, and protection from scratches.

### BACKGROUND

Many people prefer to wear accessories in or around water, but have concerns on losing the accessory when dropped into the water. Many accessories such as eyewear (e.g., glasses or sunglasses) will sink if dropped in the water unless they are buoyant. Most glasses or sunglasses are not. Conventional floatable accessories tend to be ill-fitting (either detaching too easily or being too difficult to attach), bulky, and ineffective and there does not exist an easy and stylish way to protect the accessory from scratches, keep it from slipping off your head, and keep it from sinking.

### SUMMARY

In general, a tube-like assembly for protecting and floating eyewear includes a first opening, a second opening, and a channel connecting the first opening and second opening, the channel formed by an outer surface and a cavity structured to coaxially receive and cover a portion of an eyewear temple while allowing at least a portion of an eyewear temple tip to remain exposed.

In certain embodiments, a first opening is formed by an angled cut. In certain embodiments, the second opening is formed by an angled cut. In certain embodiments, the tube-like assembly has the first opening is formed by a closed walls (such as a closed tube). In certain embodiments, the second opening is formed by an open or V-shaped or U-shaped wall. In certain embodiments, the first opening and second opening are formed by closed walls. In certain embodiments, the first and second opening are formed by open walls.

In certain embodiments, a tube-like assembly further includes a third opening positioned on a ventral surface of a tube-like assembly. In certain embodiments, a tube-like assembly further includes a third opening positioned on a dorsal surface of a tube-like assembly. In certain embodiments, the tube-like assembly includes a third opening on a ventral surface and a fourth opening on a dorsal surface of a tube-like assembly.

In certain embodiments, the first opening and second opening are formed by angled cuts. In certain embodiments, the tube-like assembly is made of a shape memory polymer material. In certain embodiments, the tube-like assembly is made of ethylene vinyl acetate material. In certain embodiments, the tube-like assembly is made of poly ethylene-vinyl acetate material. In certain embodiments, the tube-like assembly is made of a hydromorphic polymer.

In general a method of manufacturing a tube-like assembly comprising providing a material capable of being cut and shaped into a tube; and shaping the material according to a final tube-like design including a first opening, a second opening, and a channel connecting the first opening and second opening, the channel formed by an outer surface and a cavity that coaxially receives and covers a portion of an eyewear temple while allowing at least a portion of an eyewear temple tip to remain exposed.

In certain embodiments, shaping the material includes cutting the material to make a ventral opening. In certain embodiments, shaping the material includes cutting the material to make a dorsal opening. In certain embodiments, shaping the material includes heating the material form a tube-like shape. In certain embodiments, shaping the material includes heating the material to join two surfaces to form a tube-like shape. In certain embodiments, shaping the material includes joining two surfaces with an adhesive to form a tube-like shape. In certain embodiments, shaping the material includes forcing the material through a shaped die. In certain embodiments, shaping the material includes arranging the material within a heated mold, placing the material under pressure so that it contacts all parts of the mold, and keeping the material under heat and pressure until the material is cured.

In certain embodiments, a method of protecting eyewear includes providing eyewear comprising two eyewear arms, providing a tube-like assembly for protecting and floating eyewear comprising a first opening, a second opening, a channel connecting the first opening and second opening, the channel formed by an outer surface and a cavity that coaxially receives and covers a portion of an eyewear temple, and inserting at least one of the eyewear arms through the tube-like assembly. The method can further include providing a second tube-like assembly and inserting a second eyewear arm through the tube-like assembly.

Other aspects, embodiments, and features will be apparent from the following description, the drawings, and the claims.

### BRIEF DESCRIPTION OF THE DRAWINGS

FIG. 1 shows a tube-like assembly with an open area on each end as well as an open area in the middle and is hollow inside.

FIG. 2 shows a tube-like assembly with an open area on one end, hollow in the middle and an open flap area on the back.

FIG. 3 shows a view of from the top (birds-eye view) of the tube-like assembly with an open area on each side.

FIG. 4 shows a view from the bottom of the tube-like assembly with an open area on the front and an open flap on the back.

FIG. 5 shows a direct view from the front of the tube-like assembly and the hole through the assembly

FIG. 6 shows a direct view from the back of the tube-like assembly and the flap opening through the assembly

FIG. 7 shows a tube-like assembly placed on the arms on a pair of glasses.

### DETAILED DESCRIPTION

The claimed tube-like assembly is an assembly having a three-dimensional conduit shape with a channel inside allowing for an eyewear temple to be passed through from one side to the other.

Eyewear such as sunglasses or glasses are comprised of a frame, a bridge, hinges, two temples and two temple tips. The frame forms the front of the glasses or sunglasses. The frame has two sections that accommodate the right and left lenses. A bridge (also known as a nose bridge or nose piece) connects the right and left sections of the frame and rests on the nose of the wearer. The temples (sometimes referred to as the arms) form the right and left sides of the eyewear. They are connected to the frame with hinges. The temple tips (also known as ear pieces), rest on the ears of the wearer and keep the eyewear secure. A tube-like assembly is structured so that it receives and rests on at least a portion of the eyewear temples yet provides buoyancy for the entire eyewear. The tube-like assembly therefore protects the temples from scratches or other environmental damage while also providing buoyancy. The bridge, hinges and temple tips remain exposed so that the fit and comfort of the eyewear is not affected by the tube-like assembly. The tube-like assembly is made of a buoyant material with openings that are strategically formed and placed to allow a secure fit over the eyewear temples while also providing a structure that is convenient to attach or detach from an eyewear temple received therethrough. One way to measure elasticity is to calculate the elastic modulus (also known as Young's modulus) of the material. The elastic modulus (E) is defined as the stress applied to the material divided by the strain. Elasticity is the ability of a deformable body to resist a distorting effect and to return to its original size and shape when that influence or force is removed. The tube-like material can have a specific elasticity that allows a wearer to insert an eyewear temple through a tube-like assembly with a secure fit that will not easily detach, and yet is elastic enough to remove from the eyewear temple when needed. The combination of the elasticity and the structure of the openings provides a structure that accomplishes the requisite functionality.

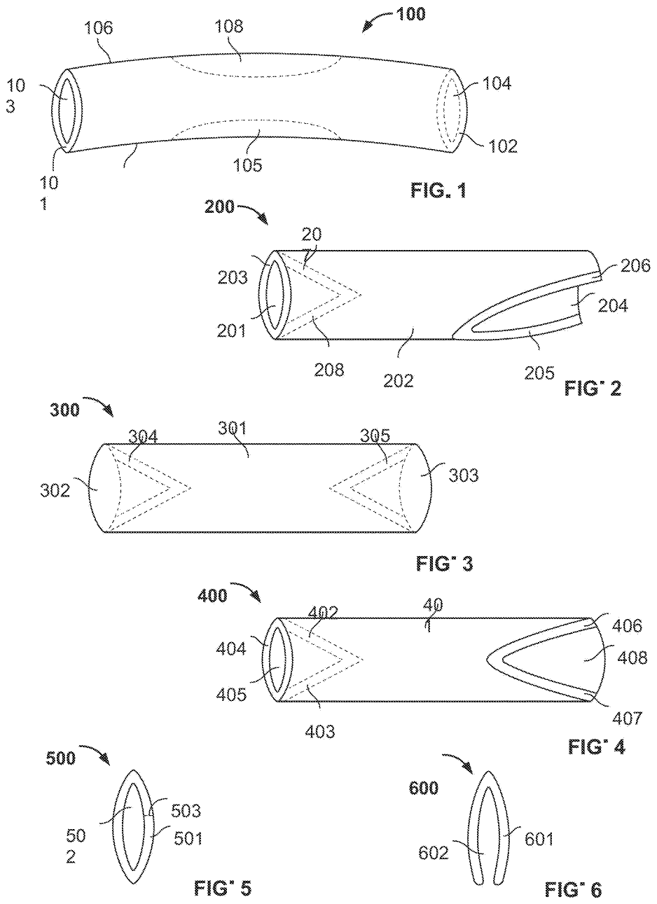

Referring to FIG. 1, the tube-like assembly 100 has a surface defined by the length from one end 101 to the other end 102 that is for example ½″ to 4″ in length. On either end there is a first opening 103 and a second opening 104 with a channel that connects the first end 101 and second end 102 and specifically designed to accommodate the eyewear temples (sometimes referred to as the arms) of sunglasses or glasses to pass through from one end to the other. The tube-like assembly must be made of a buoyant material that has some flexibility to allow easy attachment and detachment of the tube-like assembly through the eyewear temples such that only part of the eyewear temples are covered between. Once positioned, the tube-like assembly is structured such that it retains the eyewear temples securely but can also be conveniently detached. The height from 106 to 107 is for example ½″ to 4″. In certain aspects, the openings can be oval shaped defined by a closed circumference or perimeter.

In certain embodiments, the assembly can contain an optional third opening 105 at the bottom (ventral) or top (dorsal) opening 108 (shown in dashed lines) that are structured to allow more flexibility of the tube-like assembly. The openings need not have the same dimensions as long as there is solid piece of the tube-like assembly in between them to accommodate the eyewear temples.

The size of the hole on either end is measured to allow the temples of a pair of sunglasses or glasses to pass through and hold securely inside the assembly for example ½″ to 3″. It can be measured to the same height as the fixture, but it can also be less or more or less than the height of the fixture, so long as the fixture can be secured in a fixed position. The length of the assembly is measured to accommodate the fixture in a fixed position. It can be measured to have the same length as the fixture, but it can also be less or more than the length of the fixture so long as the fixture can be secured in a fixed position.

Referring to FIG. 2, the tube-like assembly 200 is shown as a cross-section taken across the z and y axes of FIG. 1. The tube-like assembly has at least one ventral 205 having a cavity 204 formed by the ventral opening 205 and opposing sidewalls 206. The opposite end opening 201 is defined by the outside walls of the opening 203 and is solid to support a fixture to pass through the center part of the assembly 202 and out the back end opening 204. The tube-like assembly contain a back opening defined by 205 on one end and front opening 201 on the other end. An optional angled cut or notch formed by a top wall 207 and a bottom wall 208 can be made on one side to provide a more convenient attachment and detachment of the tube-like assembly from the temples when allowing a fixture to pass through from one end to the other. In other embodiments the circumference of the opening on both ends is larger than the fixture as long as it allows the fixture to pass through and hold securely to the assembly.

Referring to FIG. 3, a tube-like assembly 300 has a surface 301 forming a channel that connects a first end 302 and a second end 303. In one embodiment, the first end 302 and second end 303 each have walls that are angled or V-shaped. The first angled wall 304 and second angled wall 305 allow a fixture to pass through from one side to the other with the angled cuts providing more flexibility in receiving the eyewear temples for attachment and detachment. The angled cut can have a “v” shape opening that allows the eyewear to have a broader opening on one end and a narrower opening on another end. The v-shaped openings can be symmetric (e.g. same dimensions) in certain embodiments. In other embodiments, the v-shaped openings can be of different dimensions.

Referring to FIG. 4, a tube-like assembly 400 has a surface 401 forming a channel that connects a first end 405 defined by the outside walls of the opening 404 and is solid to support a fixture to pass through the center part of the assembly 401 and out the back end opening 408. In one embodiment, the first end 405 can have a top wall 402 and a bottom wall 403 forming a V-shaped opening. The second end can have a top wall 406 and a bottom wall 407 forming a U-shaped opening. The first angled wall 402 and second angled wall 403 allow a fixture to pass through from one side to the other with the angled cuts providing more flexibility in receiving the eyewear temples for attachment and detachment.

Referring to FIG. 5, a front view is shown of the tube-like assembly 500. In this embodiment, an opening 502 can have a wall 501 that is oval-shaped to accommodate an eyewear temple. The wall can have a thickness 503. In some examples, the thickness can uniform throughout. In other embodiments, the thickness can be greater in an exposed side of the wall (facing out) compared to an inner wall (e.g. touching the wearer's head) In yet other embodiments, the thickness can be greater in greater in an inner wall compared to an exposed wall.

Referring to FIG. 6, a front view is shown of tube-like assembly 600. This embodiments shows an end 602 which is an open notch formed by sidewall 601. In certain aspects, the openings can be an open wall or a U-shaped defined by an open circumference or perimeter.

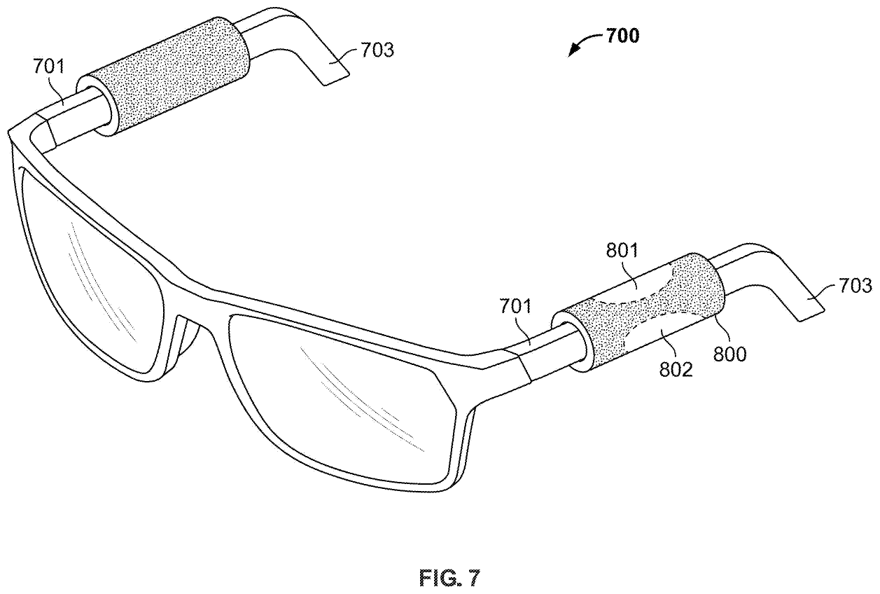

Referring to FIG. 7, the tube-like assembly 800 is shown on a pair of glasses 700 and shows where on the arms of the glasses the tube-like assembly could be installed with a space 701 between the tube-like assembly and the hinge of the glasses. In one example the tube-like assembly leaves at least a portion of the temple tips exposed on the glasses 703 and shows the optional cutout sections 801 and 802 on either side.

The tube-like assembly must provide sufficient buoyancy for the eyewear. In short, it must displace an amount liquid whose mass is greater than the total mass of the eyewear and a pair of the tube-like assemblies. The general concept is that an individual can apply a pair of the tube-like assemblies and secure a pair or eyewear temples through the claimed assemblies that will then allow the fixture to float in water and protect the fixture from scratches. The tube-like assemblies can be secured or removed easily and alternate fixtures may be used with the same tube-like assemblies. The tube-like assembly can secure the eyewear to a user's head with friction such that the eyewear does not slip off when a wearer bends down or otherwise changes direction suddenly. Securing the eyewear with the tube-like assembly means that the tube-like assembly has a sufficient coefficient of friction to keep the eyewear in place despite any force that attempts to put it in motion. The friction force always acts in the opposite direction of the intended or actual motion. The tube-like assembly must have a coefficient of friction that is effective and sufficient to overcome a motion, force, or torque that would cause the eyewear to slip.

### Materials

The tube-like assembly may be made of any suitable material that allows the assembly and secured fixture to float in water, such as ethylene vinyl acetate (EVA), poly ethylene-vinyl acetate (PEVA), plastazote, latex rubber, polyurethane (PU), polystyrene (PS), expanded polystyrene (EPS), extruded polystyrene foam (XTR or XPS), acrylonitrile butadiene styrene (ABS), polypropylene (PP), polyethylene (PE), rubber, silicone, thermoplastic polymer, hydromorphic polymers, polymeric material or other suitable material that can float in water. The material must allow the assembly to be shaped to accommodate a fixture in its cavity. In some embodiments, material can be affixed to the fixture to allow it to float in water.

In certain embodiments, the material can be a hydromorphic polymer, or similar material that is expandable upon contact with water or a liquid. Such materials is designed to float on water but due to the nature of the material, it makes contact with water it slowly expands. This allows the structure of the tube-like assembly to be thinner and have minimal volume when dry, but to expand to a requisite volume to provide buoyancy when wet

The creation of the material for the tube-like assembly and the construction of the tube-like assembly may be an injection molding process, a compression molding process, an extrusion process, or some other method to create a closed assembly.

Injection molding is a method to obtain molded products by injecting plastic materials molten by heat into a mold, and then cooling and solidifying them. The method is suitable for the mass production of products with complicated shapes, and takes a large part in the area of plastic processing.

Compression molding is a manufacturing process where a measured amount of molding material that's generally preheated (typically referred to as a charge) is compressed into the desired form using two heated molds.

Extrusion is a manufacturing process used to make pipe shaped structures. The granules melt into a liquid which is forced through a die, forming a long ‘tube like’ shape. The shape of the die determines the shape of the tube. The extrusion is then cooled and forms a solid shape.

In one embodiment, a material for forming a tube-like assembly can be pre-printed with design or logo prior to forming the tube-like assembly.

In another embodiment, the tube-like assembly can be formed, and subsequently, a design or logo can be printed on the tube-like assembly.

### EXAMPLES

### Example 1

In one example, ethylene vinyl acetate (EVA) is provided as a material. The shape is formed based on a template that is pre-measured and dimensioned to fit around eyewear temples. The material is cut including any desired openings according to the final design (including for example, any ventral or dorsal openings, and any notches or angled cuts on either end of the tube. Once both shapes are cut they refined and sanded on all corners and edges and then heat sealed to ensure a smooth surface. The material can be shaped and cut so that any of the desired openings are cut before sealing. An adhesion is then used along the refined edges and the two ends are sealed together so that a tube-like shape is formed. Once formed, the tube-like structure is sanded and heat sealed to ensure that no edges or seams are apparent creating a single closed tube with openings to allow for the eyewear arms to pass through.

### Example 2

In this example, a material such as shape-memory polymers (SMP) or hydromorphic polymers is provided. The shape is formed by first creating a mold in the pre-measured shape that is dimensioned to fit around eyewear temples. The process is completed under very high pressure where the material is injected into a mold then allowed to cure. Curing is a chemical process employed in polymer chemistry and process engineering that produces the toughening or hardening of a polymer material by cross-linking of polymer chains. Any air bubbles are removed by heating the material. Once settled the material is removed from the mold and shaped and refined further to match the predetermined dimensions. The material is then cut to specifications creating a tube-like structure that will fit around the eyewear arms. When material comes in contact with water it can expand to increase floatation and increasing the fit to the temples of the person using the eyewear. When material is dry it will return to its original shape and size.

### Example 3

In this example, a material Polyurethane (PU) is provided as a material. First a mold is created to the predetermined shape, openings, and style. This method uses a heated mold as well as heated compression material. The material is then put under pressure so that it contacts all parts of the mold. The material is kept under heat and pressure until curing is completed. Once material is cured it is removed and then shaped and refined to the exact predetermined shape and openings to create a tube-like structure allowing the eyewear arms to pass through and be secured.

### Example 4

In this example, Expanded Polystyrene (EPS) is provided as a material. In this process, the material is shaped into a preform with a hole in a single end. This preform is placed into a mold and air is then blown through it, forcing it to match the dimensions of the mold. Once it is cured, the tube-like structure is removed from the mold and shaped and refined to the predetermined shape, openings, and dimensions via sanding and heating the material. The tube-like structure can then be formed over the eyewear arms.

### Example 5

In this example, Extruded Polystyrene (XTR) is provided as a material. This method uses a polystyrene blank, or unformed shape, to create a cross section of the desired shape. The material is forced through a shaped die, allowing for a predetermined tube-like shape. Once cured the material is cut, sanded, and refined to the final tube-like shape that can be fit around the eyewear arms.

### Example 6

In this example, as a material, Polypropylene (PP) is provided. The material uses thermoforming to create the tube-like structure. First, the materials is heated until soft. When soft and pliable, the material is stretched over or into a cool mold. Once the material has adopted the shape of the mold it is cooled, so that it retains its new shape. The newly shaped material then is sanded and refined. Then the surfaces are pre-treated before bonding together. Example of how the surfaces are pretreated are flame treatment, special chemical primers, or corona/plasma treatment. All the refined pieces are then secured together with adhesive to for the predetermined tube-like assembly that will secure to the eyewear arms.

### Example 7

In this example, Polyethylene (PE) is provided as a material. The material is molded into the tube-like structure by placing it in liquid or powder resin form into a metal mold and rotating it in an oven until the resin coats the inside of the mold. The constant rotation of the mold creates a centrifugal force forming even-walled products. Once the mold cools, the hardened material is removed from the mold. Then the material is sanded and refined into the predetermined shape and openings are cut if necessary. The material is then heated and cured to the final tube-like structure.

Other embodiments are within the scope of the following claims.

What is claimed is:

1. A tube-like assembly for protecting, securing, and floating eyewear comprising
a first opening;
a second opening; and
a channel connecting the first opening and second opening, the channel formed by an outer surface and a cavity structured to coaxially receive and cover a portion of an eyewear temple while allowing at least a portion of an eyewear temple tip to remain exposed.

2. The tube-like assembly of claim 1 wherein the first opening is formed by an angled cut.

3. The tube-like assembly of claim 1, wherein the second opening is formed by an angled cut.

4. The tube-like assembly of claim 1, wherein the first opening is formed by a closed walls.

5. The tube-like assembly of claim 1, wherein the second opening is formed by an open wall.

6. The tube-like assembly of claim 1 wherein the first opening and second opening are formed by closed walls.

7. The tube-like assembly of claim 1, wherein the first and second opening are formed by open walls.

8. The tube-like assembly of claim 1 further comprising a third opening positioned on a ventral surface of a tube-like assembly.

9. The tube-like assembly of claim 1 further comprising a third opening positioned on a dorsal surface of a tube-like assembly.

10. The tube-like assembly of claim 1 further comprising a third opening on a ventral surface and a fourth opening on a dorsal surface of a tube-like assembly.

11. The tube-like assembly of claim 1, wherein the first opening and second opening are formed by angled cuts.

12. The tube-like assembly of claim 1, wherein the tube-like assembly is made of [insert] material.

13. The tube-like assembly of claim 1, wherein the tube-like assembly is made of ethylene vinyl acetate material.

14. The tube-like assembly of claim 1, wherein the tube-like assembly is made of poly ethylene-vinyl acetate material.

15. The tube-like assembly of claim 1, wherein the tube-like assembly is made of a hydromorphic polymer.

16. A method of manufacturing a tube-like assembly comprising
providing a material capable of being cut and shaped into a tube; and
shaping the material according to a final tube-like design including
a first opening;
a second opening; and
a channel connecting the first opening and second opening, the channel formed by an outer surface and a cavity that coaxially receives and covers a portion of an eyewear temple while allowing at least a portion of an eyewear temple tip to remain exposed.

17. The method of claim 16, wherein shaping the material includes cutting the material to make a ventral opening.

18. The method of claim 16, wherein shaping the material includes cutting the material to make a dorsal opening.

19. The method of claim 16, wherein shaping the material includes heating the material form a tube-like shape.

20. The method of claim 16, wherein shaping the material includes heating the material to join two surfaces to form a tube-like shape.

21. The method of claim 16, wherein shaping the material includes joining two surfaces with an adhesive to form a tube-like shape.

22. The method of claim 16, wherein shaping the material includes forcing the material through a shaped die.

23. The method of claim 16 wherein shaping the material includes arranging the material within a heated mold, placing the material under pressure so that it contacts all parts of the mold, and keeping the material under heat and pressure until the material is cured.

24. A method of protecting eyewear comprising
providing eyewear comprising two eyewear arms;
providing a tube-like assembly for protecting, securing and floating eyewear comprising
a first opening;
a second opening;
a channel connecting the first opening and second opening, the channel formed by an outer surface and a cavity that coaxially receives and covers a portion of an eyewear temple while allowing at least a portion of an eyewear temple tip to remain exposed; and
inserting at least one of the eyewear arms through the tube-like assembly.

25. The method of claim 24 further comprising providing a second tube-like assembly and inserting a second eyewear arm through the tube-like assembly.
